(19) United States
(12) Patent Application Publication
(10) Pub. No.: US 2012/0089701 A1
(43) Pub. Date: Apr. 12, 2012

(54) SYSTEM AND METHODOLOGY FOR COMPUTER-IMPLEMENTED NETWORK OPTIMIZATION

(76) Inventor: SACHIN GOEL, East Walpole, MA (US)

(21) Appl. No.: 13/267,929

(22) Filed: Oct. 7, 2011

Related U.S. Application Data
(60) Provisional application No. 61/390,638, filed on Oct. 7, 2010.

(51) Int. Cl. G06F 15/16

(52) U.S. Cl. 709/217

(57) ABSTRACT

This invention relates to system and methodology for computer implemented network optimization of products offered by network offering entity. It also relates to methodologies and systems to optimize selection and delivery of products offered by network offering entity to network participating entities to ensure higher network gain to at least one of the entities. The network option offering entity dynamically integrates its data with network participating entity' requirements and thereby optimizing the value to provide higher network gain.

This application claims priority from U.S. provisional Ser. No. 61/390,638 filed Oct. 7, 2010 entitled “system and methodology for computer-implemented network optimization.”

### FIELD OF INVENTION

The invention relates to system and methodology for computer implemented network optimization of products offered by network offering entity. It relates to methodologies and systems to optimize selection and delivery of products offered by network offering entity to network participating entities in order to ensure higher network gain to at least one of the said entities.

### BACKGROUND

Many companies, especially service provider companies like airline industry, car rental, cruise, special events, automobile rentals, etc. are facing significant challenges in today's competitive environment. Increased level of competition from ever increasing market players, global recession, unused inventory of products (higher price products as well as lower price products), among others, are various factors affecting company profits and have created economically unhealthy competition where the companies resort to attract customers by offering discounts in prices without actually understanding the requirements and utility value of the customers. It is more of a unilateral approach wherein the companies optimize within their own periphery. It is a limited area of optimization.

Companies usually don't have complete grasp of their customers' (including existing as well as potential customers') requirements, perceived value etc. for various products and services. The parameters that influence customers' decision regarding their relative perceivable payable value or even budgeting on particular products or services offered by companies are very dynamic and vary from customer or customer and also from time to time for the same customer. Otherwise, company would be more precise in keeping its inventory, offerings and delivery schedule and would be in better position to place a value for those products with such terms that provide higher network gain to at least the customers as well as company.

Every customer assigns a different value on each aspect of a product and may not require all features of a product or may not be willing to pay for one or few features and may be willing to forego the same and unless the company could allow same, it may lose that customer. At the same time, there might be another customer willing to have one or more of those features of products or services and willing to pay price for that. Therefore, either the company has to optimize the customers' requirements, perceived value etc. or may lose the customer, or may be at least one of the kinds of customers. The situation becomes trickier when products in question are perishable in nature and also of high monetary value. The company faces the dilemma of either to lower the price and face future revenue dilution, or to write off its unused capacity/excess supply for higher monetary value products or services.

As a result, there is always a gap as to products or services desired by customers and offered by companies. This gap is a manifestation of the facts that (1) companies have an incomplete grasp of customers' relative requirements, perceived value etc. for the products (which are dynamic) and (2) a company's costs structure, profits and inventory (which may usually control what the company may offer) are also dynamic. However, it is also in major part a manifestation of the lack of information technology tools which can close the gap. To collect dynamic customer and company data and then employ those dynamic data to close the gap is a complex technical problem. In these competitive times, companies cannot afford to lack flexibility in terms of customers' dynamic requirements, perceived value etc. for their products and services considering that factors for selection as well as delivery of products and services are dynamic and unless customers' requirements, perceived value etc. are effectively captured, there is likelihood of losing the customer.

From the above discussion, it is clear that flexibility of customers may be mapped or utilized to satisfy the fixed (or less flexible) demand of other customers. An environment or network wherein the network option offering entity has an insight of the customers' requirements, perceived value etc may allow it to be more exact and precise in its ordering, staffing and delivery, meaning have a much better and focused short term plans based. It may help in reducing a lot of inefficiencies and may also increase revenue and profitability. It may also help the company to pass on the reduced costs to the customer while simultaneously improving profits.

There is no system or method available that can help companies to match the availability of their products to their customers' requirements, perceived value etc., that too while concurrently optimizing and maximizing value to at least one of them i.e. company and/or its customers.

Therefore, a mechanism is required that allows a company to capture customers' requirements, perceived value etc. for products and services of the company and considering company' inventory of products, relative demand of product and other relevant factors, optimizes value to provide higher network gain to at least one of the customers as well as company.

### SUMMARY OF THE INVENTION

In response to aforementioned, the present invention herein provides for a system and methodology that allows companies to optimize their product or services with customers' requirements, perceived value etc. (implicitly or explicitly, in advance or in quasi-real-time) and to dynamically integrate these requirements, perceived value etc. with products or services offered by the company to concurrently optimize and provide higher value gain to at least one of the customers (i.e., network participating entities) and the company (i.e., the network option offering entity). Shown hereinafter are general framework of such systems and methods that allows companies to optimize their product or services with customers' requirements, perceived value etc. (implicitly or explicitly, in advance or in quasi-real-time) and to dynamically integrate these requirements, perceived value etc. with products or services offered by the company to concurrently optimize and provide higher value gain to at least one of the customers (i.e., network participating entities) and the company (i.e., the network option offering entity).

In one aspect of the present invention, the computer-implemented network optimization system, comprises of a first data processor, said first data processor which is configured to receive and store data having with respect to at least one product offered by network option offering entity in a data store, at least one corresponding conditional dynamic network option; a second data processor, said second data processor which is configured to receive at least one input for said conditional dynamic network options, to select products, from at least one network participating entity; a third data processor, said third data processor which is configured to receive at least one input given to said network to define said selected products, using at least one optimized filter including, but not limited to, at least one network gain factor that prefers selection of those products that provide higher network gain to at least one of the network option offering and/or participating entities; a fourth data processor, said fourth data processor which is configured to deliver at least one said product to at least one of said network participating entities on satisfaction of embodying condition, whereby after each said delivery, said selected product is available for utilization; and a fifth data processor, said fifth data processor which is configured to record the data pertaining to said delivered products in a data store. The conditional dynamic network option represented on said data store of said first processor with respect to said products may be an option to utilize lesser number of products than the total selected products. Said fifth data processor may be adapted to continue to update the data stored on the data store of said first data processor for any further network optimization till all products offered by the network option offering entity are defined and delivered. Said first data processor may be adapted to store and provide relevant data regarding products offered by network option offering entity, in said data store. Said second data processor may be adapted to receive at least one input that defines network participating entities' requirements regarding utilizing selected products. Said fifth data processor may be adapted to record the data pertaining to said requirements, in said data store.

In another aspect of the present invention, the computer-implemented method for network optimization, comprises the steps of providing a first data processor having a data store and which is configured to receive and store data in said data store; receiving and storing data having with respect to at least one product offered by network option offering entity, at least one corresponding conditional dynamic network option, in said first data processor; providing a second data processor which is configured to receive at least one input for said conditional dynamic network options, to select products, from at least one network participating entity; receiving at least one input for said conditional dynamic network options, to select products, from at least one network participating entity; providing a third data processor having at least one optimized filter including, but not limited to, at least one network gain factor and which is configured to receive at least one input given to said network to define said selected products; receiving at least one input given to said network to define said selected products; operating said optimized filter; wherein said optimized filter prefers selection of those products that provide higher network gain to at least one of the network option offering and/or participating entities; providing a fourth data processor which is configured to deliver at least one said product to at least one of said network participating entities; delivering at least one said product to at least one of said network participating entities on satisfaction of embodying condition, whereby after each said delivery, said selected product is available for utilization; providing a fifth data processor having a data store and which is configured to record the data pertaining to said delivered products in said data store; and recording the data pertaining to said delivered products in said data store of said fifth data processor. The conditional dynamic network option represented on said data store of said first processor with respect to said products may be an option to utilize lesser number of products than the total selected products. Said fifth data processor may continue to update the data stored on the data store of said first data processor for any further network optimization till all products offered by the network option offering entity are defined and delivered. Said first data processor may store and provide relevant data regarding products offered by network option offering entity, in said data store of said first data processor. Said second data processor may receive at least one input that defines network participating entities' requirements regarding utilizing selected products. Said fifth data processor may record the data pertaining to said requirements, in said data store.

In yet another aspect of the present invention, the computer-implemented network optimization system, comprises of a first data processor, said first data processor which is configured to deliver a first conditional dynamic network option to at least a first network participating entity to select products, where said condition allows utilization of lesser number of products than the total selected products; a second data processor; said second data processor which is configured to deliver a second conditional dynamic network option to at least a second network participating entity to select products, where said condition allows utilization of lesser number of products than the total selected products; a third data processor; said third data processor which is configured to record the information pertaining to said dynamic network options in a data store; a fourth data processor; said fourth data processor which is configured to receive at least one input given to said network to define each of said selected products for actual utilization by at least one network participating entity, whereby after each of said selected products is defined, said network participating entity can utilize said selected products; a fifth data processor; said fifth data processor which is configured to receive at least one input given to said network wherein the network option offering entity defines said selected products for actual utilization for at least another said network participating entity, using at least one optimized filter including, but not limited to, at least one network gain factor that prefers selection of those products that provide higher network gain to at least network option offering entity by ensuring delivery of maximum possible products to said network participating entity; whereby after each of said selected products is defined, said network participating entity can utilize said selected products; and a sixth data processor; said sixth data processor which is configured to record the information pertaining to said defined products, in a data store.

In yet another aspect of the present invention, the computer-implemented method for network optimization, comprises the steps of providing a first data processor which is configured to deliver a first conditional dynamic network option to at least a first network participating entity to select products, where said condition allows utilization of lesser number of products than the total selected products; delivering said first conditional dynamic network option to at least a first network participating entity; providing a second data processor which is configured to deliver a second conditional dynamic network option to at least a second network participating entity to select products, where said condition allows utilization of lesser number of products than the total selected products; delivering said second conditional dynamic network option to at least a second network participating entity; providing a third data processor having a data store and which is configured to record the information pertaining to said dynamic network options in said data store; recording the information pertaining to said dynamic network options in said data store; providing a fourth data processor which is configured to receive at least one input given to said network to define each of said selected products for actual utilization by at least one network participating entity; receiving at least one input given to said network to define each of said selected products for actual utilization by at least one network participating entity, whereby after each of said selected products is defined, said network participating entity can utilize said selected products; providing a fifth data processor having at least one optimized filter including, but not limited to, at least one network gain factor and which is configured to receive at least one input given to said network; receiving at least one input given to said network; whereby the network option offering entity defines said selected products for actual utilization for at least another said network participating entity; operating said optimized filter that prefers selection of those products that provide higher network gain to at least network option offering entity by ensuring delivery of maximum possible products to said network participating entity; whereby after each of said selected products is defined, said network participating entity can utilize said selected products; providing a sixth data processor having a data store and which is configured to record the information pertaining to said defined products, in said data store; and recording the information pertaining to said defined products, in said data store.

In yet another aspect of the present invention, the computer-implemented network optimization system, comprises of a first data processor, said first data processor which is configured to receive and store data in a data store having with respect to plurality of products offered by at least one network option offering entity, plurality of corresponding conditional dynamic network options; a second data processor, said second data processor which is configured to receive at least one input for said conditional dynamic network options, to select products, from at least one network participating entity; a third data processor, said third data processor which is configured to record the data pertaining to said selected conditional dynamic network options in a data store, on satisfaction of embodying condition; a fourth data processor which is configured to receive at least one input for said selected conditional dynamic network options, for delivery of selected products; a fifth data processor which is configured to receive at least one input given to said network to define said selected products, using at least one optimized filter including, but not limited to, at least one network gain factor that prefers selection of those products that provide higher network gain to at least one of the network option offering and/or participating entities; a sixth data processor which is configured to deliver at least one said product to said network participating entity, whereby after each said delivery, said selected product is available for utilization; and a seventh data processor which is configured to record the data pertaining to said delivered products in a data store. Said seventh data processor may be adapted to continue to update the data stored on the data store of said third data processor for any further network optimization. Said conditional dynamic network option represented on said data store of said first processor with respect to said products, may be an option to utilize selected products within definite time frame.

In yet another aspect of the present invention, the computer-implemented method for network optimization, comprises the steps of providing a first data processor having a data store and which is configured to receive and store data in said data store; receiving and storing data having with respect to plurality of products offered by at least one network option offering entity, plurality of corresponding conditional dynamic network options, in said first data processor; providing a second data processor which is configured to receive at least one input for said conditional dynamic network options, to select products, from at least one network participating entity; receiving at least one input for said conditional dynamic network options, to select products, from at least one network participating entity; providing a third data processor which is configured to record the data pertaining to said selected conditional dynamic network options in a data store; recording the data pertaining to said selected conditional dynamic network options in said data store of said third data processor, on satisfaction of embodying condition; providing a fourth data processor which is configured to receive at least one input for said selected conditional dynamic network options, for delivery of selected products; receiving at least one input for said selected conditional dynamic network options, for delivery of selected products; providing a fifth data processor having at least one optimized filter including, but not limited to, at least one network gain factor and which is configured to receive at least one input given to said network to define said selected products; receiving at least one input given to said network to define said selected products; operating said optimized filter; wherein said optimized filter prefers selection of those products that provide higher network gain to at least one of the network option offering and/or participating entities; providing a sixth data processor which is configured to deliver at least one said product to at least one of said network participating entities; delivering at least one said product to at least one of said network participating entities, whereby after each said delivery, said selected product is available for utilization; providing a seventh data processor having a data store and which is configured to record the data pertaining to said delivered products in said data store; recording the data pertaining to said delivered products in said data store of said seventh data processor. Said seventh data processor may continue to update the data stored on the data store of said third data processor for any further network optimization. Said conditional dynamic network option represented on said data store of said first processor with respect to said products, may be an option to utilize selected products within definite time frame.

In yet another aspect of the present invention, the computer-implemented network optimization system, comprises of a first data processor, said first data processor which is configured to record data pertaining to at least one conditional dynamic network option for assigning to at least another product offered by said or any other network option offering entity, in a data store; a second data processor; said second data processor which is configured to receive at least one input given to said network that allows at least one network participating entity to receive at least one conditional dynamic network option for said assignment; a third data processor; said third data processor which is configured to receive at least one input given to said network, to receive and process using at least one optimized filter including, but not limited to, at least one network gain factors to determine from among all or substantially all possible combinations of said network participating entities, a set of network participating entities that may be assigned, and which provides higher network gain to at least network option offering entity; a fourth data processor; said fourth data processor which is configured to receive at least one input given to said network to assign said network participating entity if condition on said option is satisfied; a fifth data processor; said fifth data processor which is configured to record and update the data pertaining to said assignment in a data store; wherein said fifth data processor continues to update the data stored on said data store of said first data processor for any further network optimization till all products offered by the network option offering entity are defined and delivered; a sixth data processor; said sixth data processor which is configured to receive an input given to said network, from at least another network participating entity, willing to select at least one said product from which any said network participating entity has been assigned; a seventh data processor; said seventh data processor which is configured to receive at least one input given to said network, to receive and process said data using at least one optimized filter including, but not limited to, at least one network gain factor to determine from among all or substantially all possible combinations of said network participating entities, a set of network participating entities that selected products from where any network participating entity has assigned, that prefers selection of those products that provide higher network gain to at least one of the network option offering and/or participating entities; and an eighth data processor; said eighth data processor which is configured to record the data pertaining to said assignment and any subsequent delivery, in a data store. Said first data processor may be adapted to record data having potential value to be realized by network option offering entity by assigning at least one network participating entity from at least one product to at least another product, in said data store. Said eighth data processor may be adapted to continue to update the data stored on the data store of said first data processor for any further network optimization till all products offered by the network option offering entity including the products from where any network participating entity has assigned are defined and delivered.

In yet another aspect of the present invention, the computer-implemented method for network optimization, comprises the steps of providing a first data processor having a data store and which is configured to record data pertaining to at least one conditional dynamic network option for assigning to at least another product offered by said or any other network option offering entity; recording data pertaining to at least one conditional dynamic network option for assignment to at least another product offered by said or any other network option offering entity in said data store of said first processor; providing a second data processor which is configured to receive at least one input given to said network that allows at least one network participating entity to receive at least one conditional dynamic network option for said assignment; receiving at least one input given to said network, that allows at least one network participating entity to receive at least one conditional dynamic network option for said assignment; in said second data processor; providing a third data processor having at least one optimized filter including, but not limited to, at least one network gain factor and which is configured to receive at least one input given to said network; receiving at least one input given to said network; in said third data processor; receiving and processing said data using said optimized filter to determine from among all or substantially all possible combinations of said network participating entities, a set of network participating entities that may be assigned, and which provides higher network gain to at least network option offering entity; in said third data processor; providing a fourth data processor which is configured to receive at least one input given to said network to assign said network participating entity if condition on said option is satisfied; receiving at least one input given to said network to assign said network participating entity if condition on said option is satisfied; in said fourth data processor; providing a fifth data processor having a data store and which is configured to record the data pertaining to said assignment in said data store and to continuously update the data stored on said data store of said first data processor; recording and updating continuously by said fifth data processor, the data stored on said data store of said first data processor for any further network optimization till all products offered by the network option offering entity are defined and delivered; providing a sixth data processor which is configured to receive an input given to said network, from at least another network participating entity, willing to select at least one said product from which any said network participating entity has been assigned; receiving an input given to said network, from at least another network participating entity, willing to select at least one said product from which any said network participating entity has been assigned; in said sixth data processor; providing a seventh data processor having at least one optimized filter including, but not limited to, at least one network gain factor and which is configured to receive at least one input given to said network, to receive and process said data using at least one optimized filter including, but not limited to, at least one network gain factor to determine from among all or substantially all possible combinations of said network participating entities, a set of network participating entities that selected products from where any network participating entity has assigned, that prefers selection of those products that provide higher network gain to at least one of the network option offering and/or participating entities; receiving at least one input given to said network, in said seventh data processor; receiving and processing said data using said optimized filter to determine from among all or substantially all possible combinations of said network participating entities, a set of network participating entities that selected products from where any network participating entity has assigned, that prefers selection of those products that provide higher network gain to at least one of the network option offering and/or participating entities; in said seventh data processor; providing an eighth data processor having a data store and which is configured to record the data pertaining to said assignment and any subsequent delivery in said data store; and recording the data pertaining to said assignment and any subsequent delivery, in said data store of said eight data processor. Said first data processor may record data having potential value to be realized by network option offering entity by assigning at least one network participating entity from at least one product to at least another product, in said data store. Said eighth data processor may continue to update the data stored on the data store of said first data processor for any further network optimization till all products offered by the network option offering entity including the products from where any network participating entity has assigned are defined and delivered. The condition may require the network participating entity to relinquish at least one right. At least one right relinquished by any said network participating entity may be offered to any other network participating entity.

In yet another aspect of the present invention, the computer-implemented network optimization system, comprises of a first data processor, said first data processor which is configured to record data pertaining to at least one conditional dynamic network option for assigning to at least another product offered by said or any other network option offering entity, in a data store; a second data processor; said second data processor which is configured to receive at least one input given to said network that allows at least one network participating entity to receive at least one conditional dynamic network option for said assignment; a third data processor; said third data processor which is configured to receive an input given to said network, from at least another network participating entity, willing to select at least one said product from which any said network participating entity may be assigned; a fourth data processor; said fourth data processor which is configured to receive at least one input given to said network, to receive and process using at least one optimized filter including, but not limited to, at least one network gain factor to determine from among all or substantially all possible combinations of said network participating entities, a set of network participating entities that may be assigned, and which provides higher network gain to at least network option offering entity; a fifth data processor; said fifth data processor which is configured to receive at least one input given to said network to assign said network participating entity if condition on said option is satisfied; a sixth data processor; said sixth data processor which is configured to receive at least one input given to said network, to receive and process said data using at least one optimized filter including, but not limited to, at least one network gain factor to determine from among all or substantially all possible combinations of said network participating entities, a set of network participating entities that selected products from where any network participating entity has assigned, that prefers selection of those products that provide higher network gain to at least one of the network option offering and/or participating entities; a seventh data processor; said seventh data processor which is configured to receive at least one input given to said network to define and deliver said products to said network participating entity; and an eighth data processor; said eighth data processor which is configured to record the data pertaining to said assignment and any subsequent delivery, in a data store. Said first data processor may be adapted to record data having potential value to be realized by network option offering entity by assigning at least one network participating entity from at least one product to at least another product, in said data store. Said third data processor may be adapted to receive input from said network participating entities, in respect of products more than the actual number of products from which any said network participating entity may be assigned. Said eighth data processor may continue to update the data stored on the data store of said first data processor for any further network optimization till all products offered by the network option offering entity including the products from where any network participating entity has assigned are defined and delivered.

In yet another aspect of the present invention, the computer-implemented method for network optimization, comprises the steps of providing a first data processor having a data store and which is configured to record data pertaining to at least one conditional dynamic network option for assigning to at least another product offered by said or any other network option offering entity; recording data pertaining to at least one conditional dynamic network option for assignment to at least another product offered by said or any other network option offering entity in said data store of said first processor; providing a second data processor which is configured to receive at least one input given to said network that allows at least one network participating entity to receive at least one conditional dynamic network option for said assignment; receiving at least one input given to said network, that allows at least one network participating entity to receive at least one conditional dynamic network option for said assignment; in said second data processor; providing a third data processor which is configured to receive an input given to said network, from at least another network participating entity, willing to select at least one said product from which any said network participating entity may be assigned; receiving an input given to said network, from at least another network participating entity, willing to select at least one said product from which any said network participating entity may be assigned; in said third data processor; providing a fourth data processor having at least one optimized filter including, but not limited to, at least one network gain factor and which is configured to receive at least one input given to said network; receiving at least one input given to said network; in said fourth data processor; receiving and processing said data using said optimized filter to determine from among all or substantially all possible combinations of said network participating entities, a set of network participating entities that may be assigned, and which provides higher network gain to at least network option offering entity; in said fourth data processor; providing a fifth data processor which is configured to receive at least one input given to said network to assign said network participating entity if condition on said option is satisfied; receiving at least one input given to said network to assign said network participating entity if condition on said option is satisfied; in said fifth data processor; providing a sixth data processor having at least one optimized filter including, but not limited to, at least one network gain factor and which is configured to receive at least one input given to said network, to receive and process said data using said optimized filter to determine from among all or substantially all possible combinations of said network participating entities, a set of network participating entities that selected products from where any network participating entity has assigned, that prefers selection of those products that provide higher network gain to at least one of the network option offering and/or participating entities; receiving at least one input given to said network, in said sixth data processor; receiving and processing said data using said optimized filter to determine from among all or substantially all possible combinations of said network participating entities, a set of network participating entities that selected products from where any network participating entity has assigned, that prefers selection of those products that provide higher network gain to at least one of the network option offering and/or participating entities; in said sixth data processor; providing a seventh data processor which is configured to receive at least one input given to said network to define and deliver said products to said network participating entity; receiving at least one input given to said network to assign said network participating entity; in said seventh data processor; providing an eighth data processor having a data store and which is configured to record the data pertaining to said assignment and any subsequent delivery in said data store; and recording the data pertaining to said assignment and any subsequent delivery, in said data store of said eight data processor. The said first data processor may record data having potential value to be realized by network option offering entity by assigning at least one network participating entity from at least one product to at least another product, in said data store. Said third data processor may receive input from said network participating entities, in respect of products more than the actual number of products from which any said network participating entity may be assigned. Said eighth data processor may continue to update the data stored on the data store of said first data processor for any further network optimization till all products offered by the network option offering entity including the products from where any network participating entity has assigned are defined and delivered. The condition to assign may require the network participating entity to relinquish at least one right. At least one right relinquished by any said network participating entity may be offered to any other network participating entity.

In yet another aspect of the present invention, said data processor may be adapted to record data having potential value to be realized by network option offering entity by assigning at least one network participating entity from at least one product to at least another product, in said data store.

In yet another aspect of the present invention, condition to assign may require the network participating entity to relinquish at least one right.

In yet another aspect of the present invention, at least one right relinquished by any said network participating entity may be offered to any other network participating entity.

In yet another aspect of the present invention, the delivery of the products or services may be implicit or explicit. Similarly, the delivery of the products or services may be a physical delivery or an electronic delivery or any combination of at least one of the.

In yet another aspect of the present invention, at least two of said data processors may be a single data processor.

In yet another aspect of the present invention, said conditional dynamic network option with respect to said products may be an option to utilize lesser number of products than the total selected products.

In yet another aspect of the present invention, said data processor may be adapted to continue to update the stored data for any further network optimization till all products offered by the network option offering entity are defined and delivered.

In yet another aspect of the present invention, said first data processor may be adapted to store and provide relevant data regarding products offered by network option offering entity, in said data store.

In yet another aspect of the present invention, said data processor may be to receive at least one input that defines network participating entities' requirements regarding utilizing selected products.

In yet another aspect of the present invention, said data processor may be adapted to record the data pertaining to said requirements, in said data store.

In some aspects or implementations of the present invention, there may be more than a single network option offering entity or the conditional dynamic network option may be offered by an entity which itself is not selling the products or services or is agent of one or more network option offering entity. However, in other implementations or aspects there may be only single network option entity or said option may be offered on behalf on only single network option entity.

Also in some aspects or implementations of the invention, the conditional dynamic network option may only be an obligation to make payment and may include a soft value and unless such payment is made there may not be any delivery of product or services. However, in other implementations, said condition may also be waiver of one or more rights, privileges or perks associated with the product.

Another aspect of the invention is that one or more aspects or implementations as mentioned herein may be combined in one or more ways to perform the invention.

In all aspects or implementations of the present invention, the network option offering entity or company may be, any product or service offering entity, including but not limited to, one or more entities in airline industry, hospitality industry, rent/hire/purchase/lease industry, tours & travel industry, and any other allied industry. The other features and advantages of the invention will be apparent from the following description and the appended claims.

### BRIEF DESCRIPTION OF THE DRAWING

FIG. 1 is a diagrammatic illustration of computer implemented network showing interaction between network participating entity and network option offering entity and using optimized filters for higher network gain;

FIG. 2 is a block diagram of the system as taught herein for achieving computer implemented network optimization;

FIG. 3 is a flow chart illustrating computer implemented network optimization along with continuous optimization in the network as described herein;

FIG. 4 is a flow chart illustrating computer implemented network optimization for one of the methods of performing assignment as described herein;

FIG. 5 is a flow chart illustrating computer implemented network optimization for another method of performing assignment as described herein;

### DETAILED DESCRIPTION

The following detailed description is of the best currently contemplated mode of carrying out the invention. The description is not to be taken in a limiting sense, but is made merely for the purpose of illustrating the general principles of the invention, since the scope of the invention is best defined by the appended claims. Selected illustrative embodiments according to the invention will now be described in detail, as the inventive concepts are further amplified and explicated. These embodiments are presented by way of example only. In the following description, numerous specific details are set forth in order to provide enough contexts to convey a thorough understanding of the invention and of these embodiments.

It will be apparent, however, to one skilled in the art, that the invention may be practiced without some or all of these specific details. In other instances, well-known features and/or process steps have not been described in detail in order to not unnecessarily obscure the invention. One should not confuse the invention with the examples used to illustrate and explain the invention. Various inventive features are described below that can each be used independently of one another or in combination with other features. However, any single inventive feature may not address any of the problems discussed above or may only address one of the problems discussed above and therefore at least a plurality of inventive features disclosed may be required to be considered to address the problems discussed above.

Various embodiments according to the present invention will now be described herein detail. These embodiments are described with examples and specific details to provide enough contexts for better understanding of the invention and its various embodiments. It will be apparent, however, to one skilled in the art, that the invention may be practiced without some or all of these specific details. The examples used herein are used only for the purpose of illustration and explanation. The features and advantages of the invention may be better understood with references to drawings and description as follows.

The following terms and definitions given below may be needed to understand the features, aspects and scope of the invention.

The term “computer-implemented network optimization system” as described herein, means and includes, without any limitation, a dynamic system that provides a computer implemented network to optimize selection and delivery of products offered by network offering entity to network participating entities in order to ensure higher network gain to at least one of the said entities using one or more data processors, and/or where selection of products to be delivered is through one or more optimised filters, including without limitations one or more network gain factors. The options offered for products by said system are conditional and dynamic. They vary depending upon various factors like availability, time, shelf life etc. to enable the system to achieve the highest possible gain in the network.

The term “network option offering entity” or “network option offering entities” described herein includes, but is not limited to, company or companies, individual(s), group of individual(s), traders, manufacturers, channel partners, merchants or vendors (including their agents) of services as well as goods and any agent working on behalf of the company or number of companies in providing conditional dynamic network options and optimizations. The term “entity” may include singular as well as its plural significance. The Network Option Offering Entity also includes, without limitation, a company, a group and/or consortium of companies, any entity formed by company(s) (whether or not solely for this purpose) or any combination thereof that offers conditional dynamic network options on its own products and/or other company goods/products/services.

The term “Product” refers to, without limitation, a product or service provided by a network option offering entity

The term “network participating entity” here includes, without limitation, one or more entities buying/entering into a contract to buy a company's product or service eg. customer.

The term “optimize” refers to enhancement and is not intended to require achievement of a mathematical minimum or maximum.

The term “transaction” here implies, without limitation, to do, to carry or to conduct an agreement or exchange or any act explicit enough to demonstrate intention towards accepting any offer with its terms and conditions. The exchange may or may not involve a price in terms of monetary or non-monetary value from customer side. The parties participating in the transaction may have obligation(s) from various terms and conditions. In other words, transaction may also imply an action or activity involving two or more parties that reciprocally affect or influence each other.

The term “payment” here implies the act of paying or the state of being paid. The term “payment” here implies an amount of money or any other consideration in cash/kind or otherwise paid at a given time or which has been received in the past but for which the benefit of the same is realized now, may be in part or in totality. “Payment” may also refer to a transfer of something of value to compensate for products or services that have been, or will be, received. Payment may be made in cash, on credit or any other consideration. The payment may have monetary or non-monetary (soft) value. The payment can be from one or more network option offering entities and/or one or more other entities to one or more network participating entities or from one or more network participating entities to one or more network option offering entities and/or one or more other entities or any combination thereof.

The term “price” may include, but is not limited to, a set of one or more Product Prices, a set of one or more conditional dynamic network option prices, any other price or any combination of the above. The price may consist of a monetary value or a soft value (e.g., benefits, coupons or exchange of another service) or other consideration. The price may be fixed or variable, with or without bounds and price conditions may be determined by the network participating entities, network option offering entities, a third entity, or any combination thereof, at one or more times. “Pricing” may include Static, dynamic or quasi-static pricing. Static pricing is fixed price assigned at infrequent intervals. Dynamic pricing is determined by an algorithm either on an on-demand basis for a particular transaction or at frequent intervals so as to yield pricing based on near (i.e., quasi) real time network option offering entity's performance data. Quasi-static pricing would be somewhere between the former two situations, such as pricing done quarterly or monthly based on then-current information about the network option offering entity.

The term “server”, “processor” or “data processor” includes, without limitation, any one or more devices for processing information. Specifically, a processor may include a distributed processing mechanism. Without limitation, a processor may include hardware, software, or combinations thereof; general purpose digital computing elements and special purpose digital computing elements and likewise included. A single processor may perform numerous functions and may be considered a separate processor when implementing each function. The servers may include, but are not limited to, web servers, application servers, database servers and networking servers. The terms “database” and “data store” may have been used interchangeably as and when the context requires and at least one of the may refer to any form of storing the data, including but not limited to, storing the data in a structured form, storing the data in an unstructured form and so forth. Database may include, but is not limited to, email database, conditional dynamic network option database, inventory database, network participating entities' database, network option offering entities' database etc.

The term “dynamic conditional options” as described herein, means and includes, without any limitation, options that are conditional in nature i.e. are with an embodying condition for use of product, time frame within which it may be used/consumed, or may include some restraint in use of product or purchase of product which may be inherently constrained to use and vary depending upon various factors like availability, time, shelf life etc. to enable the system to achieve the highest possible gain in the network. The dynamic conditional options may vary after each selection and/or delivery of product and enable network to maximize gain.

The term “optimised filter” as described herein, means and includes, a filter program that runs one or more algorithms, on one or more predetermined criteria and/or pre determined set of instructions etc. The optimised filter performs optimisation of network participating entity's requirements, preferences etc. with network option offering entity's products for providing higher network gain to at least one of them. It helps in achieving gain to a network and the gain may be achieved for/from entities interacting in the network and/or entities outside of such network. The optimisation is to be achieved in real time as the network being dynamic continues to change and update. It filters the available data/factors that may be updated real time based on various inputs from network participant or offering entity or any other entity.

The term “network gain factor” as described herein, means and includes, data at least having information concerning the gain expected to achieve from selection and/or delivery of products. The gain may be direct or indirect gain to the entire network and/or may be segregated at individual level. In a preferred system, both network gain factor and optimisation filter have to work together and the network gain factor helps in optimizations and filtering. The optimisation is to be achieved in real time as the network being dynamic continues to change and update. The network gain factors are very dynamic and may be updated real time based on various inputs from network participant or offering entity or any other entity.

The term “requirement” herein includes, without limitation, network participating entities' perceived values, needs, preferences, utilities whether relative or not associated with one or more products, services, conditional dynamic network options etc.

The term “economics” herein includes, without limitation, network option offering entity's cost (fixed/semi-fixed/variable), revenues, inventory, capacity, constraints, product value/delivery costs, ancillary costs, future projections and details, data, facts and figures, other information about the network option offering entity's products, services, conditional dynamic network options etc.

The term “assign” herein means and include without limitations, elevate, promote, upgrade, advance, raise demote, relegate, bump, shift, downgrade, move, transfer etc. The term “assign” herein may also include without limitation “reassign” wherein a network participating entity is assigned something at first and later on is being reassigned something else and so on. The term assign may also include without limitation assigning one or more products in at least one set of configuration to one or more products in another set of configurations.

The singular word or expression herein, without deviation from its original context may also include the plural inference of the singular word/expression.

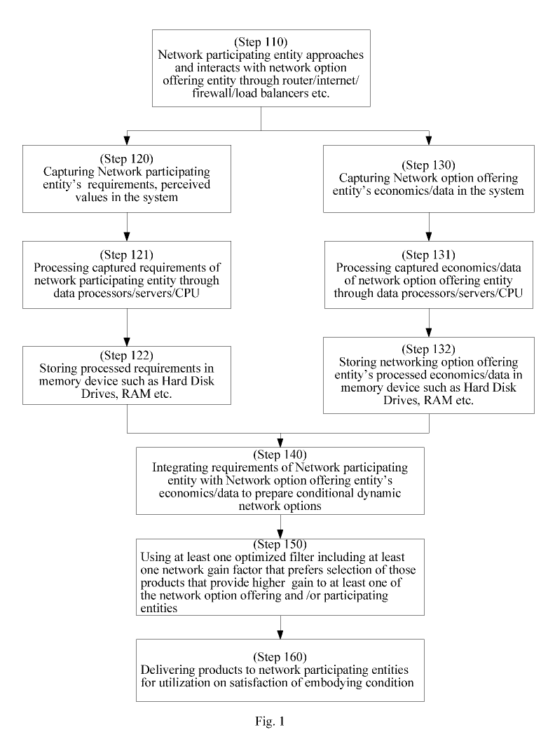

FIG. 1 shows a diagrammatic illustration of computer implemented network showing interaction between network participating entity and network option offering entity and using optimized filters for higher network gain. It involves the following steps: In Step 110, network participating entity approaches and interacts with network option offering entity through various routers/internet/firewalls/load balancers. In Step 120, the network participating entity's requirements, perceived values etc. are captured. In Step 121 said captured requirements are processed through one or more data processors or servers or CPU and in Step 122 processed requirements are stored in one or more memory devices such as hard disk drives or RAM etc. In Step 130, the network option offering entity's economics/data are captured, in Step 131 the captured economics/data is processed and in Step 132 the processed economics/data is stored in one or more memory devices such as hard disk drives or RAM. In Step 140, the stored requirements of network participating entity is integrated with the stored economics/data of network option offering entity to prepare conditional dynamic network options. In Step 150, at least one optimized filter including, at least one network gain factor is used to select those products that offer higher network gain to at least one of the network participating entity and/or network option offering entity. In Step 160, the products are delivered to network participating entity on satisfaction of one or more embodying conditions.

The network option offering entity may with the help of present invention interact with the network participating entity through one or more mechanisms such as a web site, a call centre and/or direct interaction at one or more designated/non designated centres of the network option offering entity or one or more combinations of these to determine in detail their requirements, perceived value etc. for the products/services/conditional dynamic network options offered by said network option offering entity or of any other entity. Said interaction and various inputs and requirements of the network participating entity may be recorded and such information may be stored in one or more structured data forms or any other mechanisms. One of the methods may be a web-based questionnaire to collect this information in a structured manner. The collected information may then be stored or associated with the profile of the network participating entity in a database. Said database or any other data store may contain various other default selections of one or more requirements, perceived value etc. of the network participating entity. Based on the same, the network option offering entity may segregate various network participating entities on the basis of one or more network participating entities' requirements etc. It may also be possible that one network participating entity may fall in one category at one point of time and in another category at a different point of time.

Network option offering entity may formulate conditional dynamic network options for one or more network participating entities by integrating its economics/data and various requirements of one or more network participating entities. Such integration may be done at a granular level wherein each network participating entity's requirements may be handled by the network option offering entity in a different manner. As discussed earlier, different network participating entities may derive different utility from different aspects of the same product at the same time. It may be possible that one network participating entity may derive different utility from the same product at different time. For example, in a network of various network participating entities and one or more network option offering entities, a network participating entity having an important business meeting may value the timely ticket to the destination of the business meeting much more than another network participating entity that may be flexible to take a trip either weekend and hence the network option offering entity may provide one or more conditional dynamic network options to the network participating entities keeping in view of their requirements using at least one optimized filter including network gain factor so that a higher network gain can be achieved. In another aspect of this, a network consisting of a network participating entity who when on a business trip may check in for a deluxe room in a hotel near airport wherein said network participating entity may prefer to take a family suite in a hotel located in the heart of the city while on vacations with family. Consequently, the network option offering entity may need, in some way, to define and learn about these value parameters, requirements, perceived values etc of the network participating entities at an individual as well as at a group level. The conditional dynamic network options so formulated by the network option offering entity may help in targeting the individual requirements of the network participating entities and may also help in satisfying such requirements at a group level. There may or may not be a price to one or more such conditional dynamic network options provided by the network option offering entity.

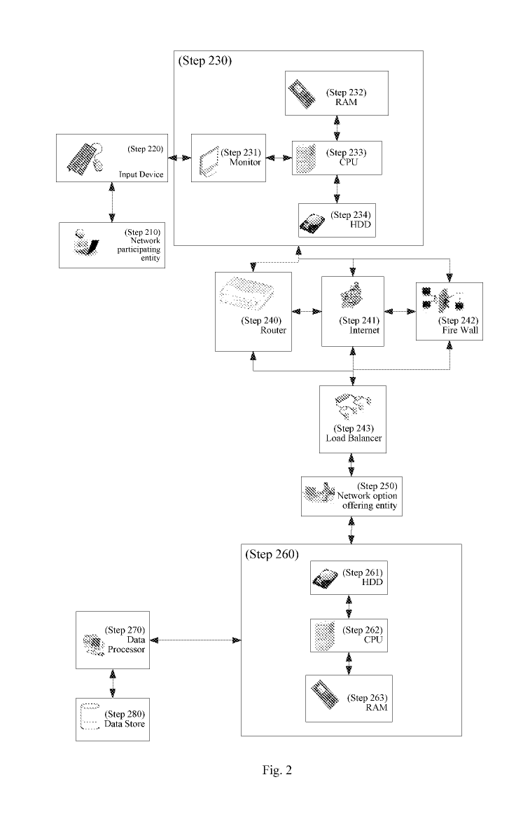

In FIG. 2, a block diagram of the system for achieving computer implemented network optimization is shown. In Step 210, one or more network participating entities approach and interact with one or more network option offering entities using one or more input devices (as shown in Step 220). One or more inputs regarding one or more requirements of the network participating entities are provided in Step 230 through one or more components as shown in Step 231, Step 232, Step 233, Step 234 such as monitors, processing devices (such as CPU etc), storage devices (Hard Disks, RAMs etc). Said requirements are passed through one or more Routers (Step 240), internet (Step 241), firewalls (Step 242), load balancers (Step 243).

Said requirements may then be captured by the network option offering (Step 250) entity using one or more devices (as shown in Step 260) such as Hard disk drives (Step 261), CPU/other processors (Step 262), RAM (Step 263) etc. The captured requirements may then be integrated with various economics/data of the network option offering entity as discussed earlier in FIG. 1. The integration and data exchange may involve one or more data processors (Step 270) and one or more data stores (Step 280). The data exchange may be in one or more transactions or may be back and forth between the network option offering entity and network participating entities wherein at least one optimized filter including, at least one network gain factor help in providing network gain to at least one of the network option offering entity and/or network participating entities. The data store and/or data processors may be represented with “n” (where “n” is a natural integer) which may signify that the network may involve more than one data processor and/or data stores.

One or more requirements/inputs (as shown in FIG. 2) are provided through one or more input devices such as the CPU/Hard Disk Drives/RAM etc. The configuration of RAM may depend upon different factors and it may be used as memory device while processing the inputs provided by the network participating entity. The information/input provided by the network participating entity may reach the network option offering entity through one or more series of Routers, Internet, Firewall, Load Balancers and other hardware. One or more load balancers may help the network option offering entity to distribute load coming various sources including network participating entity across one or more servers of the network option offering entity or to another entity or any combination thereof. There may be just one interaction or constant interactions between the network option offering entity and network participating entity. Said requirements are then captured and may be integrated with various economics of the network option offering entity and one or more conditional dynamic network options may be formulated. Said integration may involve one or more data processors and/or data stores including, without limitation, one or more secondary data processors and/or data stores that may only be in the “Read Only” form and may be updated through one or more replication servers. Network option offering entity may use various other mechanisms and techniques for updating and storing said information of the requirements of the network participating entities and also of the interaction with them. One such method may be to have one or more separate temporary data processors and/or data stores wherein the information/data/requirements may be constantly processed, updated and stored. The processed information in the temporary data processors and/or data stores may be removed as and when required.

The network option offering entity may interact with the network participating entities through Internet, one or more routers, one or more firewalls etc. Where applicable, the application data processors/servers used by network option offering entity or its agent (may be one or more entities other than network option offering entity and/or network participating entities) may also distribute load between one or more servers of agent and/or the network option offering entity through one or more load balancers. Agent may interact through one or more input devices and input information may be processed by one or more CPU with the use of one or more RAM, Hard Disk Drives (HDD). Agent may interact with the network option offering entity through the Intranet or may interact through a series of one or more routers, firewalls and Internet or highly secured Intranet to keep the system and application secured. The agent may also appoint one or more sub-agent that may input through one or more input devices. The information may be processed through the monitor, one or more hard disk drives, RAM and CPU respectively. The sub-agent may interact with agent of the network option offering entity through highly secured Intranet to keep the system and application secured.

Next step is to make real-time/quasi-real time assessment of network option offering entity's economics/data as illustrated in FIG. 1. After analysing network option offering entity's economics/data, said information is processed and such processed information may be integrated with network participating entity' requirements, perceived value etc. to formulate one or more conditional dynamic network options for network participating entity to optimally customize the products to provide higher network gain including, but not limited to, enhancement of the value for network participating entity, while simultaneously maximizing business profitability for network option offering entity.

Conditional dynamic network options may have a positive impact on the network option offering entity operations, while simultaneously enhancing the overall product utility for the network participating entity. It may be prepared in such a way to produce cost savings or revenue enhancement for network option offering entity operations while concurrently enhancing value for the network participating entity in terms of its one or more requirements or perceived value etc for one or more products. Conditional dynamic network options may have one or more initial costs, may generate revenues and/or may create other benefits/conditions for the network option offering entities and/or network participating entities. Said revenue may be incremental revenues/savings to the network option offering entity and/or network participating entity. One or more conditions attached with the conditional dynamic network options offered by the network option offering entity may depend upon various factors/circumstances which may include, without limitation, relinquishment of one or more rights, obligation for additional payments for utilizing one or more additional services/features of the product, one or more payment conditions for selection of the product/conditional dynamic network option, one or more benefits which may or may not be contingent on happening of one or more events, conditions relating to utilization of the products which may include, without limitation, when to utilize, how much to utilize etc., mandatory purchase of at least one inherently constrained product etc.

Once the requirements, perceived value etc. of the network participating entity are captured, one or more data processors/server applications run one or more search algorithms corresponding to such requirements in association with one or more data processors/servers of the network option offering entity to search for one or more conditional dynamic network options. There may be one or more interactions between the network participating entity and network option offering entity which may involve one or more back and forth communication between the network participating entity and network option offering entity. The network participating entity may modify one or more requirements during such interaction or at any other time. The network option offering entity may provide some information to the network participating entity in order to facilitate the modification of one or more requirements by network participating entity.

The search algorithm may interact back and forth with one or more database/data stores and may present network participating entity with one or more conditional dynamic network options. Conditional dynamic network options may be chosen by the network participating entity or it may be possible that based on the requirements of the network participating entity, network option offering entity may choose and select one or more conditional dynamic network options for the network participating entity. In one of the implementation, the conditional dynamic network options may be selected together by network participating entity and network option offering entity. In the event, no conditional dynamic network option is selected; network participating entity may or may not modify one or more of its requirements.

Once the conditional dynamic network option is finalized and selected; a payment transaction may be executed (if any) and one or more databases may be accordingly updated through internet, firewall. Said updates may also be done through one or more routers, highly secured VPN Network etc. There may be corresponding updates in the secondary databases also (which may be in “read only” format) through one or more replication servers. Alternatively, the network option offering entity may have one or more separate temporary database structure wherein the entries may be updated and stored until the final update is made in one or more main databases. One the final update is done, the entries in these temporary databases may be removed/deleted/discarded.

The web page and/or the application may be hosted on the network option offering entity's server, agent's server, any third entity's server and/or any combination thereof. The entire network system or process may run at the premises of agent, network option offering entity and/or any third entity or any combination thereof. It may also be possible to run a part of the system at one place and rest at one or more other places. The network system may also be implemented even if one or more servers/data processors may be kept off-shore locations and may be accessed remotely. The structure or the interaction architecture of the system may vary depending on factors including, but not limited to, the set up of the network option offering entity, changes in the technology and with the introduction of new and better technology enhancing the interaction process.

Present system and methodology may be used to provide discounts to network participating entity where in one of the conditions in the conditional dynamic network option, the network participating entity would be required to utilise lesser number of products or utilise the products within a fixed time frame. The network option offering entity may get benefit (whether through cost savings incremental revenues, customer loyalty etc) in the process as it may get commitment for one or more of its products. Network option offering entity may sell the unused products to one or more other network participating entities and may earn more profit, generate cost savings etc. The network participating entity may get advantage due to one or more value discounts which may be provided by the network option offering entity. Conditional dynamic network options may also provide the network participating entities one or more confirmed products. For example, a network option offering entity may offer a conditional dynamic network option to network participating entities to make a commitment to buy 50 products over a period of twelve months. This may provide the network option offering entity economies of scale as it may now foresee the future demand and may allocate the resources in much efficient manner. There is also higher network gain as network participating entities may also be benefited as various discounts might be offered by the network option offering entity as this conditional dynamic network option has provided a better insight in to the demand of the network participating entities.

In another example, in a network where a network participating entity who may need to visit a city every weekend may purchase a conditional dynamic network option from the network option offering entity wherein the price of every trip may be fixed by the network option offering entity or may be decided mutually. One or more conditions in the conditional dynamic network option may require the network participating entity to utilise at least a minimum number of trips, say 20 trips, in a fixed time period (say, within 12 months). There may or may not be a condition on the utilization of the maximum number of trips under said conditional dynamic network option. There may be another condition that the network participating entity may be required to notify the network option offering entity by a certain time period whether said trip will be availed on a particular weekend or not. The time period to notify the network option offering entity may differ from one trip to another. For example, the network participating entity may be required to notify the network option offering entity, at least 7 days prior for 10 trips, and at least 3 days prior for up to 6 trips, and at least 12 hrs prior for up to 4 trips (or there may be no notice period required in some cases). The Network option offering entity may confirm the defined products (specific rail schedules) in some cases to the network participating entity within a few hours of a request being made to up to may be few days (or even more) in other cases. For example, once the network participating entity makes a request to network option offering entity for a specific trip on a given set of days, the network option offering entity may confirm a final train within x hours or days of receiving such a request. The notice or confirmation time period(s) may be decided by the network option offering entity, network participating entity, any other entity, or may be jointly by any of these in some cases and/or may be individually in the other cases. In another implementation, the confirmation from the network option offering entity may be within a fixed time period before commencement of said trip. In another implementation of this invention, the network participating entity may have the choice to allow a third entity instead to utilize one or more trips. The network participating entity may assign one or more trips to another entity, which may or may not attract additional pricing conditions from the network option offering entity. The conditional dynamic network option may also provide network option offering entity a choice to sell said tickets to another network participating entity if said trip is not utilised by the first said network participating entity that has availed such conditional dynamic network option. In one of the implementations of this invention, the network participating entity may have an option to change the city pair for few trips, may select some city pairs out of a range of city pair combinations (which may or may not be provided by the network option offering entity) and may have the option for some of the trips wherein no selection of city pairs is required to be made initially. This may or may not come with an option to pay additional price at the time of confirming one or more such selections. The dynamic conditional network option may have different conditions with regards to the pricing of one or more trips. The price for the entire conditional dynamic network option may include a deposit which a network participating entity may have to keep with the network option offering entity wherein there may be a right available to the network option offering entity to forfeit the deposit in the event the minimum number of trips are not met by the network participating entity. In the conditional dynamic network option, the pricing may be implemented in various ways such as there may be some trips which may have some fixed costs attached to them, in some of the trips there may be an additional cost as and when the network participating entity utilizes said trip, there may or may not be one price for all the trips and so forth. In another implementation of this invention, the network participating entity may provide various options of preference along with some margin of deviation to the network option offering entity and then network option offering entity may process such requests based on its captured economics and provide dynamic conditional network options to the network participating entity which may bring higher network gain in the entire network.

One or more requirements of one or more network participating entities may be integrated as a result of one or more conditional dynamic network options selected by them, which may result in higher network gain to the network.

One or more conditions in the conditional dynamic network options may require the one or more network participating entities to utilise the products within a fixed time frame. In one of the examples of the conditional dynamic network options, the network participating entity may select the total products in advance from the network option offering entity and may inform up to an agreed timeline about utilization of one or more products out of such selection. In another example of the conditional dynamic network options, the network option offering entity may also select and provide products to the network participating entity as per various requirements provided by the network participating entity. There may or may not be a condition to notify the network option offering entity regarding utilization of one or more products and vice versa.

At least one optimized filter including, but not limiting to at least one network gain factor, may be used in defining one or more selected products. The products may be defined by the network option offering entity, network participating entity, any other entity or any combination thereof. The products that may be defined may or may not be from the set of products selected by the network option offering entity, network participating entity, any other entity and/or any combination thereof. There may or may not be any payment obligation on either party when the products are defined outside the ones that are selected. Payment obligation may or may not be there at the time of delivery/utilization of the selected/defined products.

Conditional dynamic network options may be framed in such a manner wherein one or more condition may require one or more network participating entities to utilize less than the selected products. In such situations, the network option offering entity may offer the unutilized products to another set of network participating entity. At least one optimized filter, including but not limiting to at least one network gain factor, may be used that may prefer selection of those products that may provide higher network gain to at least network option offering entity and may ensure delivery of maximum possible products to one or more network participating entities in the network.

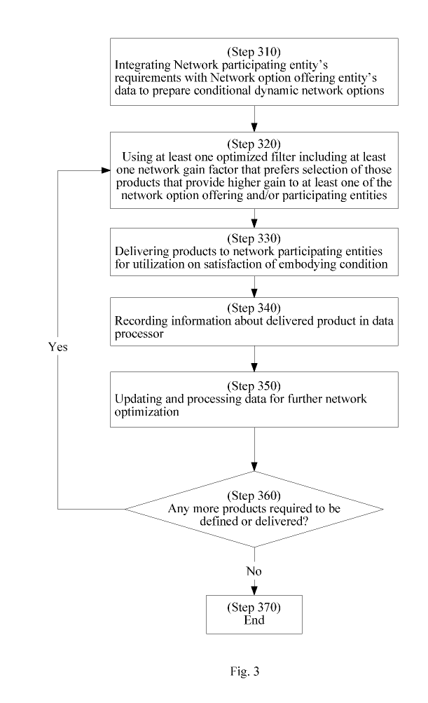

In FIG. 3 a flow chart illustrating computer implemented network optimization along with continuous optimization in the network is shown. In Step 310, the requirements of network participating entity are integrated with economic/data of network option offering entity to prepare and/or present one or more conditional dynamic network options. In Step 320, at least one optimized filter including, at least one network gain factor is used to select those products that may offer higher network gain to at least one of the network participating entity and/or network option offering entity. In Step 330, the products are delivered to network participating entity on satisfaction of embodying condition. In Step 340, the information about one or more delivered products is recorded. In Step 350, the data is updated and processed for further optimization within the network. In Step 360, a test is conducted to check if there are any more products required to be defined or delivered in the network. If the result of the check is positive, the control moves back to Step 320. If the result is negative, the control moves to Step 370 and the computer implemented network optimization is concluded.

At least one optimized filter including, but not limiting to, at least one network gain factor, may analyse the data in respect of an event and may invoke one or more optimization algorithms which may or may not be specific to the event that is detected. Said one or more algorithms may be used by at least one optimized filter to retrieve, collect and assess the data/information on the data store regarding requirements, perceived value etc. of the network participating entity and conditional dynamic network option selection along with economics/data of network option offering entity in real time. Said optimized filters may use predetermined criteria such as at least one network gain factor which may optimize network option offering entity economics along with network participating entity's requirements. This may lead to optimization of total product value for the network participating entity and optimization of profits/gains for the network option offering entity which may include, without limitation, network loyalty gains, gains from repeat business, competitive advantage, uniqueness of the products and services offered and so forth.

After optimization, the network system may deliver the defined products to one or more network participating entities, network option offering entity, any other entity and/or any combination thereof. There may be back and forth optimization within the network if the results presented are not acceptable to either the network option offering entity, network participating entity any other entity and/or any combination thereof. As shown in FIG. 3, the optimization may continue until all the products in the network system are defined and/or delivered. This may involve repeated running of one or more optimization algorithms in the network system to satisfy the requirements of one or more network participating entities. This may depend on various factors, including without limitation, availability of one or more products, requirements of one or more network participating entity, economics of one or more network option offering entity etc. Depending on the event type and related conditional dynamic network option, the algorithm may communicate optimized results one or more times. Repeated running of one or more optimization algorithms may require continuous interaction, processing and access to information which may be performed with the help of one or more hardware including, without limitation, one or more RAMs, processors, data stores etc. There may be a requirement of storing some information during the any one or more of the runs of the optimization algorithm in the form of temporary accessible data which may or may not be deleted even after the runs have been completed. The speed and other configurations of one or more hardware may also be changed or altered during one or more of the runs. It may also be possible to send one or more part of one or more algorithms to a set of processors, RAMs and/or data stores with different configurations and some parts to another set of processors, RAMs and/or data stores with completely different configurations and speeds.

At least one optimized filter including, but not limiting to, at least one optimised filter, may start their functioning at one or more times which may include, without limitation, the time when the requirements are received, at the time of integration of the requirements and the economics, at the time of preparation of conditional dynamic network options, at the time of selection of one or more conditional dynamic network options, at the time when one or more products are defined, at the time of interaction between the network participating entity and network option offering entity, at the time of occurrence of one or more events whether related or not to the conditional dynamic network option or any other time. The algorithm may make a real-time assessment of the network option offering entity's economics/operations to get up-to-date costs, capacities and constraints etc.

Information technology is an integral part and parcel of the present invention. The conditional dynamic network options and optimizations as a network system and methodology may require integration with various hardware and/or network services. The network participating entity may approach the web (server) application of the network option offering entity through Internet and one or more Firewall etc. and inputs search criteria. The medium by which a network participating entity may reach (approach) the network option offering entity web (server) application may vary depending on different conditions which may include, but not limited to, the best available communication medium at a particular time, scale and type of implementation of the conditional dynamic network options, factors of network option offering entity's choice.

One or more such kind of information technology system may be implemented for the specific conditional dynamic network options. The system may be customized as per the specific economics/data of the network option offering entity, conditional dynamic network options, its agent, any third entity, network participating entity and/or any combination thereof.

The benefit of the present system and methodology is that a new efficient approach is introduced for mapping network participating entity' requirements, perceived value etc. and preferential product value keeping in view the network option offering entity's economics, so as to optimize both to concurrently maximise gain for at least one of the network participating entities and/or network option offering entity. It may eliminate manual, time-consuming processes and may replace those with an efficient, automatic process that may be applied in mass market situation and across geographical boundaries. By enhancing value for its network participating entity, a network option offering entity may greatly improve its overall business prospects in terms of high retention rates and may wider its network by gaining new network participating entities. It may also help to increase the overall sales and thus may help increase the overall business value.

Present system and methodology may be used to bring flexibility in product offering by network option offering entity. Such conditional dynamic network options may enable network option offering entity to analyse the number of network participating entities that might be willing to assign to other products in or out of the network from their existing selection of products. The network option offering entity may gain by selling the product vacated by the existing network participating entity to other entities in the network without losing the revenue from the existing network participating entity. It may result in higher network gain wherein the existing and new network participating entities may gain from the value of the products so received while the network option offering entity may gain from widening the network across more network participating entities and also realizing the value from one or more network participating entities.

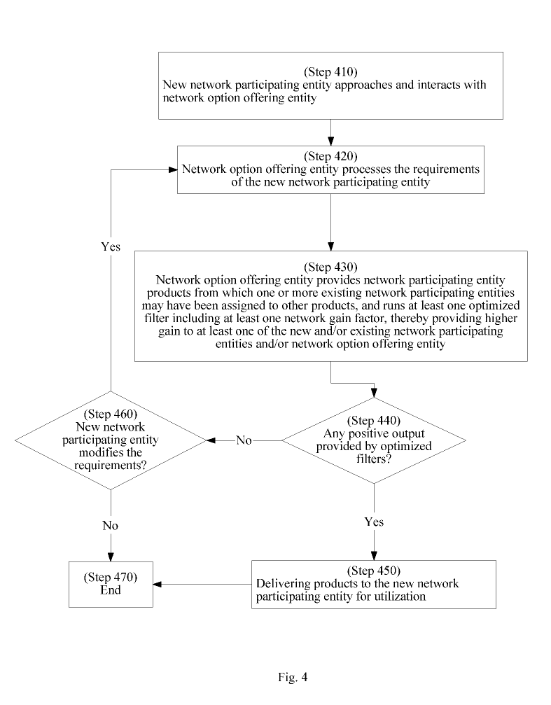

In FIG. 4, a flow chart illustrating computer implemented network optimization for one of the methods for performing assignment is shown. In Step 410, a new network option offering entity approaches and interacts with network option offering entity. In Step 420, the network option offering entity processes the requirements of the new network participating entity. In Step 430, at least one optimized filter including, at least one network gain factor is used to provide products from which one or more existing network participating entities may have been assigned to other products, thereby providing those products that offer higher network gain to at least one of the new and/or existing network participating entity and/or network option offering entity. In Step 440, a test is conducted to check if one or more options for assignment are available. If the test results in positive output (i.e. one or more options for assignment are available), the control moves to Step 450, else moves to Step 460.

In Step 450, the product is delivered to new network participating entity and the process of providing higher network gain is concluded (Step 470).

In Step 460, the new network participating entity may be required to modify one or more requirements. Once the requirements are modified the control moves back to Step 420, else the process of providing the higher network gain to at least the network participating entities and network option offering entity is concluded.

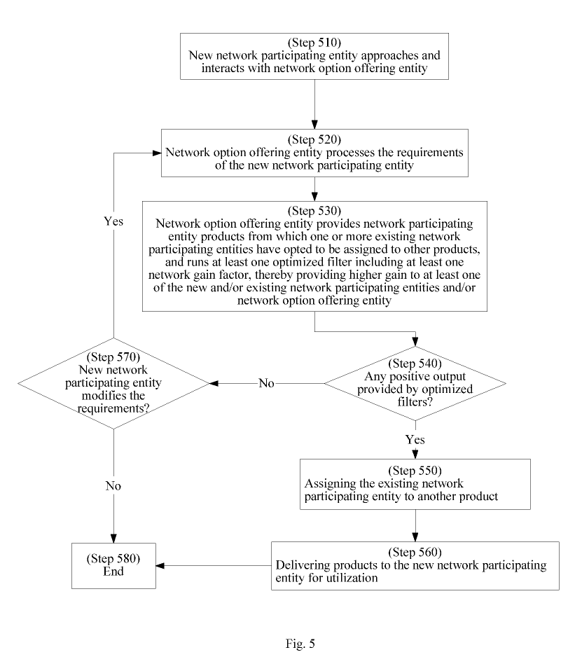

In FIG. 5, a flow chart illustrating computer implemented network optimization for another method for performing assignment is shown. In Step 510, a new network option offering entity approaches and interacts with network option offering entity. In Step 520, the network option offering entity processes the requirements of the new network participating entity. In Step 530, at least one optimized filter including, at least one network gain factor is used to provide products from which one or more existing network participating entities have already opted to be assigned to one or more other products, thereby providing those products that offer higher network gain to at least one of the new and/or existing network participating entity and/or network option offering entity. In Step 540, a test is conducted to check if one or more options for assignment are available. If the test results in positive output (i.e. one or more options for assignment are available), the control moves to Step 550, else moves to Step 570.

In Step 550, the existing network participating entity is assigned to one or more other products. Such products may or may not be in the network. In Step 560, the product is delivered to new network participating entity and the process of providing higher network gain is concluded (Step 580).

In Step 570, the new network participating entity may be required to modify one or more requirements. Once the requirements are modified the control moves back to Step 520, else the process of providing the higher network gain to at least the network participating entities and network option offering entity is concluded.

In one of the implementation, the conditional dynamic network option may let network option offering entity may conditionally offer its products (preferably high value products) to existing set of network participating entity at flexible prices where the optimized filter may trigger only at a specific time. Such products may be delivered at flexible prices only at a specific time to the existing network participating entity. For example, in a network, wherein the network option offering entity is running a movie theatre, may offer various conditional dynamic network options to various network participating entities. Here, the network option offering entities can sub divide its products in various categories such as, front stall, middle stall, upper stall and balcony. The network option offering entity may seek the requirements of one or more network participating entities earlier (through various conditional dynamic network options) wherein existing network participating entities may be assigned to the higher class in case said may be available (at a pre agreed price and at a specified time). The network option offering entity then may run one or more optimized filters, including a network gain factor which may provide the network option offering entity optimized results. The network option offering entity may assign one or more network participating entities to the higher categories of tickets as per the terms and conditions of the various conditional dynamic network options selected and thereby may result in higher network gain. In one of the other examples of the implementation, the conditional dynamic network options may be provided in such a manner that the network option offering entity may deliver the products, from which it has assigned one or more network participating entities to higher category of tickets, to new network participating entities. It may further result in higher network gain wherein more network participating entities have gained due to the optimized filters (including network gain factor) applied by the network option offering entity. In one of the implementation of the optimized filters and conditional dynamic network options, the network option offering entity may keep on selling the lower stall tickets to various network participating entities wherein resulting in overselling of the lower stall tickets. The network option offering entity may then run optimized filters and may assign one or more network participating entities to the higher categories based on the conditional dynamic network options selected, wherein satisfying the requirements of various network participating entities as per various conditional dynamic network options selected by them. In another implementation, it may be possible that the conditional dynamic network options may have selected one or more existing network participating entities that may have already opted to be assigned to the higher category. This may enable the network option offering entity to sell the lower category to a wider number of network participating entities in the network and may allow existing network participating entities to be assigned to higher category as and when required in the network. This may also help in expanding the scope, arena and the coverage of the overall network wherein more and more new network participating entities can be brought in the network.

One or more network option offering entities may also join the network in order to further benefit from the higher network gain. As more and more network option offering entities enter into the network; this may allow wider choice and may also help in providing more conditional dynamic network options to various network participating entities within the network. This will help in further building up the network and may also help in further enhancing the network gain.

In another implementation of the conditional dynamic network option of assignment, various conditional dynamic network options may be provided in such a manner that the optimized filters may use at least one network gain factor and may assign one or more existing network participating entities to another product rather than the higher category of the same product. Continuing the above example of the network in the case of the movie theatre, the conditional dynamic network options may allow the network option offering entity to assign one or more existing network participating entities to another movie, thereby re selling the vacated seat to the new incoming network participating entity.

Such conditional dynamic network options may enhance the overall experience of the network participating entities in the network, which may gradually prefer high value products of the network option offering entity. Such conditional dynamic network options may also enable the network option offering entity to create a wider network and may encourage other entities to join the network of the network option offering entity because of the dynamic network options being offered by the network option offering entity. The network option offering entity may also gain from better optimization of inventory, repeat business, network loyalty etc.

A network option offering entity may inform the network participating entity of the decision related to the assignment via any communication channel including, but not limited to, an email, phone, in-person at network option offering entity's office or sales counter, or may ask the network participating entity to contact the network option offering entity to know the decision and so forth.

In one of the other implementations of providing various conditional dynamic network options, one or more constraint products (where in one network participating entity may not be able to use all the products simultaneously) may be offered to the network participating entities. There may be an additional price for selecting such options as it may provide higher product value to the network participating entity. Continuing the above example of the network of the movie theatre, a network participating entity may want to watch a particular movie but is not sure whether the meetings will end by 4 pm or 6 pm depending on which said network participating entity can choose the show. The conditional dynamic network option may be offered in such case, wherein network option offering entity may provide the tickets for more than one show to the network participating entity with the condition to utilize only for one show. The network option offering entity may further impose a condition on said network participating entity to confirm the utilization by a pre agreed time. It may help the network option offering entity in better planning and may also offer peace of mind as in the event of meetings stretching more than anticipated, network participating entity can still watch the movie as per the conditional dynamic network option chosen by him wherein the network option offering entity has provided him the choice to choose from either of the timings. The conditional dynamic network option may be provided to another network participating entity that may be flexible to watch at any of these times. Hence, the network option offering entity may form them as a group in the network. This may help in satisfying the requirements of various network participating entities in the network while simultaneously may result in higher network gain. Once the time of the movie is selected by the first network participating entity, the other time slot could be offered to another network participating entity. This may further be implemented in various scenarios wherein conditional dynamic network options can be provided in such a manner by the network option offering entity that may have various theatres in different locations that the first network participating entity may choose few locations initially and finally settle for one location.

The system defined herein above in its preferred embodiment may also be implemented wherein the conditional dynamic network option may include an option to have one or more additional units of capacity (than what is required) which may be offered for utilization. The network participating entities may be assigned one or more products in at least one set of configuration from another set of configuration. One or more products may be same in either set of configuration. The invention may be implemented in travel industry (such as railways, airlines or surface transports etc), media and entertainment industry apart from other industries. An example in media industry may help in understanding said invention. Network option offering entity may offer conditional dynamic network option to one or more network participating entities where in the network participating entity may be assigned another set of time slots for the advertisements (which may be multiple time slots) instead of the prime time slot. Network option offering entity may also have a set of configuration for the advertisements where in it may offer network participating entity to have no conflicting or even any other advertisements from other entities during breaks in sport events (such as tennis, baseball etc) from various regular set of configurations of advertisement time slots. Yet another example of said invention in travel industry where in the conditional dynamic network option may include an option to have one or more adjoining seats to be kept as unoccupied or vacant or empty. The system may require the Network participating entity to get registered with the Network option offering entity offering the travel services or any third party which is offering such services on their behalf. The network participating entity may avail the conditional dynamic option for itself or for any other entity, in other words the network participating entity may not be the one utilising the product for itself. The Network participating entity may have the conditional dynamic network option to have one or more adjoining seats being vacant or empty. This may include keeping the middle seat empty in case of a 3 seat configuration (an aircraft having 3 seats in a row, a window, an aisle seat and a middle seat) wherein by keeping just one empty seat, the Network option offering entity may be able to satisfy the needs of 2 such Network participating entities. In yet another implementation, a Network participating entity, may choose to get a conditional dynamic network option to receive 2 or more additional empty seats next to his or her assigned seat. And if towards closure to departure, the airline does deliver the additional seats to the Network participating entity, it would enhance the travel utility to the Network participating entity as it gets more room to travel more conveniently. In yet another implementation, the Network option offering entity may keep the vacant seat to be utilized exclusively by one or more Network participating entities that may have opted for this where as in another implementation scenario; the vacant seat may not be held exclusively for any Network participating entity to utilize. There may be an obligation to make payment and payment obligation may include a soft value and unless such payment is made there may not be any delivery of product or services. However, in other implementations, said condition may also be waiver/relinquishment of one or more rights, privileges or perks associated with the product. There may or may not be any notification deadline to inform the Network participating entity if it has been awarded the additional units of capacity (seats) or not. The Network option offering entity or any third party may also decide if said product is to be delivered or not. In another implementation, the Network participating entity may also define whether said product is to be delivered to the Network participating entity or not. The Network participating entity may define deadline for making payment as per the condition attached to said conditional dynamic network options, if any. As already discussed and explained herein above, there may be direct or indirect gain to the entire network comprising the Network option offering entity, network participating entity or any third party or vendor involved in the transaction and/or any combination thereof and/or it may be segregated or individual level. In a preferred system, both network gain factor and optimization filters may work together and the network gain factor may help in optimization and filtering. The optimization may be achieved in real time as the network may be dynamic and may be updated continuously. The network gain factors may be dynamic and may be updated real time based on various inputs from network participant or offering entity or any other entity. For example: in case of airline, a traveller may have a requirement that one or more of adjoining seats on one or either side of his seat may be kept unoccupied or empty. The airline may offer same to traveller subject to the conditions attached to said conditional dynamic network options such as unused inventory, availability of such arrangement, payment (if any), number of travellers who have already opted or may opt for such conditional dynamic network options etc. Similarly, in the rail industry, during day time lower berths, within a cabin containing 2, 4 or 6 or other number of berths configuration cabins, may be shared amongst passengers and only at night time, berths may be made available to passengers (especially the one sitting at the lower berth). If the passenger intends to avail said benefit (have access to sleeping berth) even in day time, the present invention may provide him a conditional dynamic network option to have full access to berths for sleeping even at day time, by allowing him option to have the adjoining or the upper passenger berth empty or unoccupied. In other words, the conditional dynamic network option may allow a passengers travelling on a flight or rail or a bus, one or more additional seats, so that the passenger could get additional space and thus more convenience in travelling. The optimization may be performed when deciding who to award additional empty seats or not, to maximize the delivery of vacant/empty or additional seats to maximum number of passengers who have registered for it, or to maximize the total revenue gained to the traveller or any other parameter as desired by the travel providing company such as the airline, the rail company etc.

In one of the further implementations, such conditional dynamic network option may have an option for the Network participating entity to have no other traveller sitting on either side of said Network participating entity, which may also include making available a seat which is a corner seat.

The above system and method may be applied to several industries including, without limitation, airlines, hotels, rail road, automobiles, media, entertainment (television, radio, internet, etc.), furniture, insurance, computer hardware, travel (e.g., vacations, car rentals, cruises), events (such as theatre, movies, sports games etc.). There may be several other industries that may benefit by using the new system and method.

The costs, revenues, benefits and conditions shown herein are for illustration purposes only and actual values could be different depending on specific values selected by the users for conditional dynamic network options, network participating entity behaviour, network option offering entity schedule, pricing, any other factor or any combination of the above.

While the invention has been described with respect to a limited number of embodiments, those skilled in the art, having benefit of this disclosure, will appreciate that other embodiments can be devised within the spirit and scope of the invention.

It should be understood, of course, that the foregoing relates to exemplary embodiments of the invention and that modifications may be made without departing from the spirit and scope of the invention as set forth in the following claims.

What is claimed is:

1. A computer-implemented network optimization system, comprising:
a. a first data processor which is configured to receive and store data in a data store having with respect to at least one product offered by network option offering entity, at least one corresponding conditional dynamic network option;
b. a second data processor which is configured to receive at least one input for said conditional dynamic network options, to select products, from at least one network participating entity;
c. a third data processor which is configured to receive at least one input given to said network to define said selected products, using at least one optimized filter including at least one network gain factor that prefers selection of those products that provide higher network gain to at least one of the network option offering and/or participating entities;
d. a fourth data processor which is configured to deliver at least one said product to at least one of said network participating entities on satisfaction of embodying condition, whereby after each said delivery, said selected product is available for utilization; and
e. a fifth data processor which is configured to record the data pertaining to said delivered products in a data store.

2. The system as claimed in claim 1, wherein the said delivery of products could be implicit/explicit/physical/electronic delivery of products.

3. The system as claimed in claim 1, wherein said conditional dynamic network option represented on said data store of said first processor with respect to said products, is an option to utilize lesser number of products than the total selected products.

4. The system as claimed in claim 3, wherein said fifth data processor is adapted to continue to update the data stored on the data store of said first data processor for any further network optimization till all products offered by the network option offering entity are defined and delivered.

5. The system as claimed in claim 1, wherein said first data processor is adapted to store and provide relevant data regarding products offered by network option offering entity, in said data store.

6. The system as claimed in claim 5, wherein said second data processor is adapted to receive at least one input that defines network participating entities' requirements regarding utilizing selected products.

7. The system as claimed in claim 6, wherein said fifth data processor is adapted to record the data pertaining to said requirements, in said data store.

8. The system as claimed in claim 1, wherein at least two of said data processors are a single data processor.

9. A computer-implemented network optimization system, comprising:
a. a first data processor which is configured to deliver a first conditional dynamic network option to at least a first network participating entity to select products, where said condition allows utilization of lesser number of products than the total selected products;
b. a second data processor which is configured to deliver a second conditional dynamic network option to at least a second network participating entity to select products, where said condition allows utilization of lesser number of products than the total selected products;
c. a third data processor which is configured to record the information pertaining to said options in a data store;
d. a fourth data processor which is configured to receive at least one input given to said network to define each of said selected products for actual utilization by at least one network participating entity, whereby after each of said selected products is defined, said network participating entity can utilize said selected products;
e. a fifth data processor which is configured to receive at least one input given to said network wherein the network option offering entity defines said selected products for actual utilization for at least another said network participating entity, using at least one optimized filter including at least one network gain factor that prefers selection of those products that provide higher network gain to at least network option offering entity by ensuring delivery of maximum possible products to said network participating entity; whereby after each of said selected products is defined, said network participating entity can utilize said selected products; and
f. a sixth data processor which is configured to record the information pertaining to said defined products, in a data store.

10. The system as claimed in claim 9, wherein the said delivery of products could be implicit/explicit/physical/electronic delivery of products.

11. The system as claimed in claim 9, wherein at least two of said data processors are a single data processor.

12. A computer-implemented network optimization system, comprising:
a. a first data processor which is configured to receive and store data in a data store having with respect to plurality of products offered by at least one network option offering entity, plurality of corresponding conditional dynamic network option;
b. a second data processor which is configured to receive at least one input for said conditional dynamic network options, to select products, from at least one network participating entity;
c. a third data processor which is configured to record the data pertaining to said selected conditional dynamic network options in a data store, on satisfaction of embodying condition;
d. a fourth data processor which is configured to receive at least one input for said selected conditional dynamic network options, for delivery of selected products;
e. a fifth data processor which is configured to receive at least one input given to said network to define said selected products, using at least one optimized filter including at least one network gain factor that prefers selection of those products that provide higher network gain to at least one of the network option offering and/or participating entities;
f. a sixth data processor which is configured to deliver at least one said product to said network participating entity, whereby after each said delivery, said selected product is available for utilization; and
g. a seventh data processor which is configured to record the data pertaining to said delivered products in a data store.

13. The system as claimed in claim 12, wherein said seventh data processor is adapted to continue to update the data stored on the data store of said third data processor for any further network optimization

14. The system as claimed in claim 12, where in said delivery of products could be implicit/explicit/physical/electronic delivery of products.

15. The system as claimed in claim 12, wherein said conditional dynamic network option represented on said data store of said first processor with respect to said products, is an option to utilize selected products within definite time frame.

16. The system as claimed in claim 12, wherein at least two of said data processors are a single data processor.
